(19) United States
(12) Patent Application Publication
(10) Pub. No.: US 2016/0026270 A1
(43) Pub. Date: Jan. 28, 2016

(54) OPERATING METHOD OF ELECTRONIC APPARATUS AND TOUCH APPARATUS

(71) Applicants: Chih-Chien Liu, Taipei City (TW); Chun-Sheng Chen, Taipei City (TW)

(72) Inventors: Chih-Chien Liu, Taipei City (TW); Chun-Sheng Chen, Taipei City (TW)

(73) Assignee: COMPAL ELECTRONICS, INC., Taipei City (TW)

(21) Appl. No.: 14/503,425

(22) Filed: Oct. 1, 2014

(30) Foreign Application Priority Data
Jul. 24, 2014 (TW) 103125345

(51) Int. Cl. G06F 3/0354; G06F 3/041

(52) U.S. Cl. CPC G06F 3/03543; G06F 3/0416

(57) ABSTRACT

An operating method of an electronic apparatus and a touch apparatus are provided. In the method, a touch action by a user on a touch panel is detected through a controller of the touch apparatus, so as to obtain a contact region touched by the touch action on the touch panel. Subsequently, whether the touch action includes a palm touch is determined based on a size of the contact region. Under the situation that the touch action includes the palm touch, palm touching information corresponding to the palm touch is transformed into mouse controlling information through a mouse simulating device of the touch apparatus. Further, the mouse controlling information is sent to a mouse driver through the mouse simulating device, such that the mouse driver executes mouse operation based on the mouse controlling information.

### CROSS-REFERENCE TO RELATED APPLICATION

This application claims the priority benefits of Taiwan application serial no. 103125345, filed on Jul. 24, 2014. The entirety of the above-mentioned patent application is hereby incorporated by reference herein and made a part of this specification.

### BACKGROUND OF THE INVENTION

1. Field of the Invention

The invention relates to a mechanism for operating an electronic apparatus, and more particularly, relates to an operating method of an electronic apparatus and a touch apparatus capable of executing mouse operation through the touch apparatus.

2. Description of Related Art

Information technologies, wireless mobile communications, and information home appliances have been rapidly developed and widely applied. To meet current demands on portable, compact, and user-friendly IT products, touch panels have been introduced as input interfaces in replacement of conventional keyboards or mice. Presently, based on a driving method of the touch panel, the touch panel includes various categories, for example, a resistance type, a capacitor type, an acoustic-wave type and an optical type. However, when the touch panel is used to replace a traditional mouse, a precise effect may not be achieved by using the touch panel during specific operation that requires higher precision.

### SUMMARY OF THE INVENTION

The invention is directed to an operating method of an electronic apparatus and a touch apparatus capable of transforming a touch action of large area into simulation of mouse operation, such that specific operation that requires higher precision can be executed by the touch apparatus.

An operating method of an electronic apparatus of the invention includes: detecting a touch action by a user on a touch panel through a controller of a touch apparatus, so as to obtain at least one contact region touched by the touch action on the touch panel; determining whether the touch action includes a palm touch based on a size of the contact region; when the touch action includes the palm touch, transforming palm touching information corresponding to the palm touch into mouse controlling information through a mouse simulating device of the touch apparatus; and sending the mouse controlling information to a mouse driver through the mouse simulating device, such that the mouse driver executes mouse operation based on the mouse controlling information.

In an embodiment of the invention, before determining whether the touch action includes the palm touch, the operating method includes: calculating an amount of the contact region generated on the touch panel. When the touch action includes the palm touch, the operating method further includes: when the amount of the contact region is less than 2, setting the contact region as a palm region corresponding to the palm touch; calculating a center point of the palm region and using the center point as a movement reference point; and transforming first movement information of the movement reference point on the touch panel into second movement information of the mouse controlling information, wherein the palm touching information includes the first movement information.

In an embodiment of the invention, after calculating the amount of the contact region generated on the touch panel, and when the touch action includes the palm touch, the operating method further includes: when the amount of the contact region is greater than or equal to 2, setting one having a greatest area among the contact regions as the palm region corresponding to the palm touch and setting each of the remaining contact regions as a finger region corresponding to a finger touch. Subsequently, a distance between the palm region and each of the finger regions is calculated by calculating the center point of the palm region and a center point of each of the finger regions respectively. Then, the finger regions generated through the touching of the first hand which also generates the palm region are found from among the contact regions based on the distance between the palm region and each of the finger regions. Then, the movement reference point is obtained according to the center point of the palm region and center points of the finger regions generated through the touching of the first hand which also generates the palm region. Further, the first movement information of the movement reference point on the touch panel is transformed into the second movement information of the mouse controlling information through the mouse simulating device of the touch apparatus.

In an embodiment of the invention, after calculating the distance between the palm region and each of the finger regions, the distance between the palm region and each of the finger regions is compared with a preset distance. The finger regions having the distance from the palm region not greater than the preset distance is set as regions generated through a touching of a first hand. The finger regions having the distance from the palm region greater than the preset distance is set as regions generated through a touching of a second hand.

In an embodiment of the invention, after calculating the distance between the palm region and each of the finger regions, whether the finger regions generated through a touching of a second hand different from the first hand exist in the contact regions is determined based on the distance between the palm region and each of the finger regions. If the finger regions generated through the touching of the second hand exist in the contact regions, finger touching information corresponding to the finger regions are transformed into touch controlling information through a touch controlling device of the touch apparatus, and the touch controlling information is sent to a touch driver through the touch controlling device.

In an embodiment of the invention, the step of determining whether the touch action includes the palm touch based on the size of the contact region includes: determining whether an area of each of the contact region is greater than a threshold. It is determined that the touch action includes the palm touch when the contact region having the area greater than threshold exists. It is determined that the touch action does not include the palm touch when the contact region having the area greater than threshold does not exist.

In an embodiment of the invention, the step of determining whether the touch action includes the palm touch based on the size of the contact region further includes: comparing a short-side width of each of the contact region with a preset length. When the contact region having the short-side width greater than the preset length exists, it is determined that the touch action includes the palm touch. When the contact region having the short-side width greater than the preset length does not exist, it is determined that the touch action does not include the palm touch.

A touch apparatus of the invention includes a touch panel, a controller and a storage unit. The controller is coupled to the touch panel, and configured to detect a touch action by a user on the touch panel, so as to obtain at least one contact region touched by the touch action on the touch panel. The storage unit is coupled to the controller, and includes a controller firmware, a mouse simulating device and a touch controlling device, wherein the controller firmware, the mouse simulating device and the touch controlling device are executed by the controller. Herein, the controller firmware determines whether the touch action includes a palm touch based on a size of the contact region; and when the touch action includes the palm touch, the mouse simulating device transforms palm touching information corresponding to the palm touch into mouse controlling information, and the mouse simulating device sends the mouse controlling information to a mouse driver, such that the mouse driver executes mouse operation based on the mouse controlling information.

Based on above, by disposing both the touch controlling device and the mouse simulating device in the touch apparatus, not only can the mouse operation be realized through the mouse simulating device when the large-area touching (the palm touch) is detected, the touch operation can also be realized through the touch controlling device when a non large-area touching (the finger touch) is detected. Accordingly, the touch apparatus is capable of providing two operating methods for the user to operate the electronic apparatus.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a touch apparatus according to an embodiment of the invention.

FIG. 2 is a flowchart of an operating method of an electronic apparatus according to an embodiment of the invention.

FIG. 3A and FIG. 3B are schematic diagrams illustrating forms of hand touching according to an embodiment of the invention.

FIG. 4 is a block diagram of an electronic apparatus according to an embodiment of the invention.

FIG. 5 is a flowchart of an operating method of an electronic apparatus according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

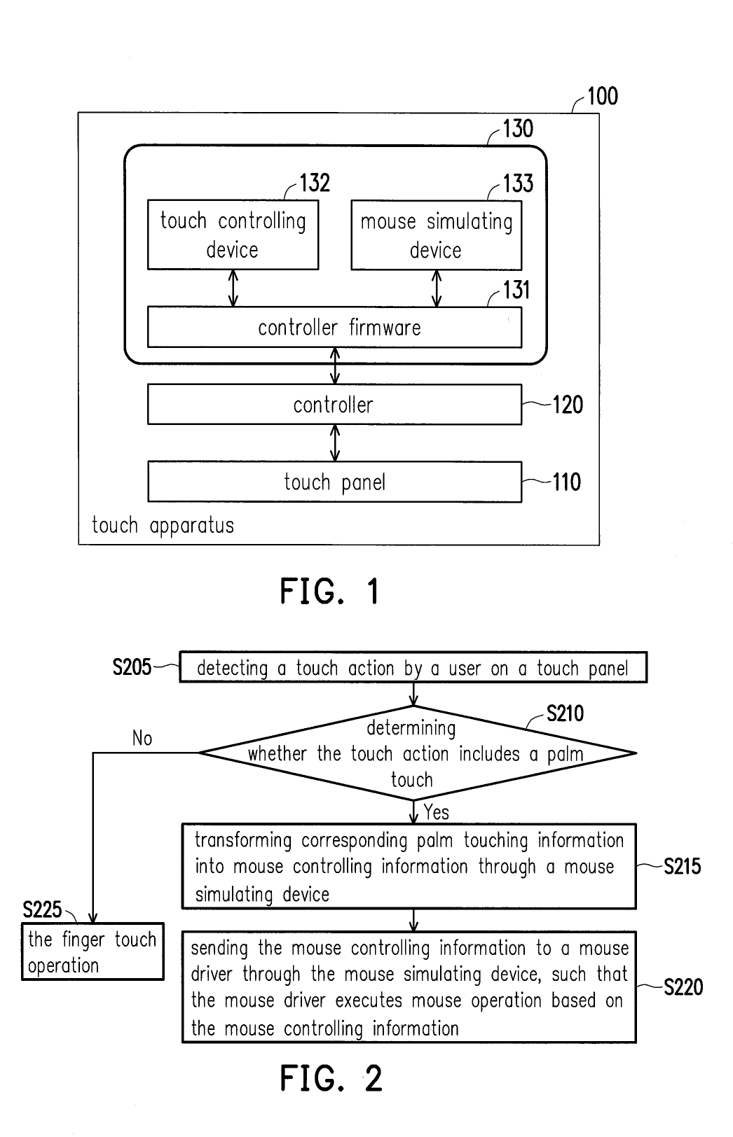

FIG. 1 is a block diagram of a touch apparatus according to an embodiment of the invention. Referring to FIG. 1, a touch apparatus 100 includes a touch panel 110, a controller 120 and a storage unit 130. The controller 120 is coupled to the touch panel 110 and the storage unit 130.

The touch panel 110 may be a resistance type, a capacitor type, an acoustic-wave type, an optical type, and etc. according to a driving method and a structural design thereof. The controller 120 is configured to detect a touch action by a user on the touch panel 110, so as to obtain at least one contact region touched by the touch action on the touch panel 110. The storage unit 130 includes a controller firmware 131, a touch controlling device 132 and a mouse simulating device 133. The controller firmware 131, the touch controlling device 132 and the mouse simulating device 133 are executed by the controller 120.

The mouse simulating device 133 is added into the touch apparatus 100 in order to send palm touching information corresponding to a palm touch to a mouse driver of an operating system through the mouse simulating device 133 when the controller 120 determines that the touch action includes the palm touch through the controller firmware 131.

Steps of an operating method of an electronic apparatus are described below with reference to the touch apparatus 100. FIG. 2 is a flowchart of an operating method of an electronic apparatus according to an embodiment of the invention. Referring to FIG. 1 and FIG. 2 together, in step S205, a touch action by a user on the touch panel 110 is detected through the controller 120 of the touch apparatus 100, so as to obtain at least one contact region touched by the touch action on the touch panel 110.

Subsequently, in step S210, the controller firmware 131 determines whether the touch action includes a palm touch based on a size of the contact region. Generally, the palm touch is regarded as an inadvertently touch, such that the controller 120 ignores a palm touching information corresponding to the palm touch. Yet, in the present embodiment, the controller 120 does not ignore the palm touching information corresponding to the palm touch, and instead, the controller 120 drives the mouse simulating device 133 to execute subsequent actions when the palm touch is detected.

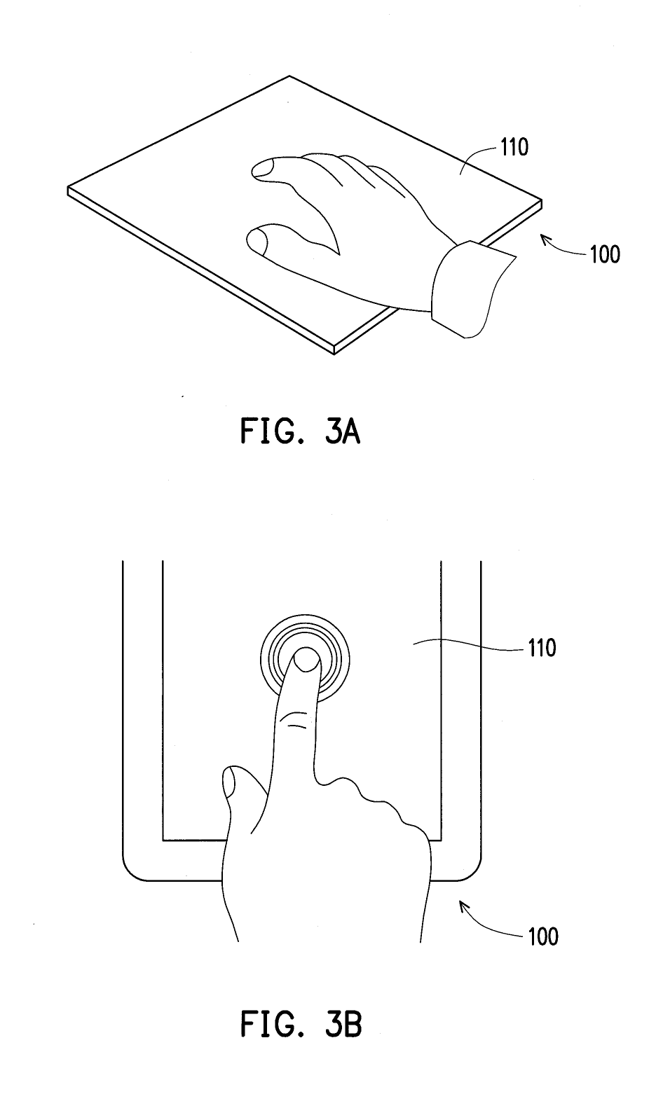

In this case, whether the contact region is a large-area touching (i.e., the palm touch) is determined by determining whether an area of the contact region is greater than a threshold. For example, after the area of the contact region is calculated, whether the calculated area is greater than 144 mm² (i.e., the threshold) can be determined. For instance, FIG. 3A and FIG. 3B are schematic diagrams illustrating forms of hand touching according to an embodiment of the invention. FIG. 3A illustrates a palm touch and FIG. 3B illustrates a finger touch. As shown by the palm touch depicted in FIG. 3A, an area of the contact region touched by the entire hand on the touch panel 110 of the touch apparatus 100 is far greater than an area of the touch region touched only by a finger on the touch panel 110 as depicted in FIG. 3B. Accordingly, when the area of the contact region is greater than the threshold, the controller firmware 131 determines that the touch action includes the palms touch.

Alternatively, whether the touch action includes the palm touch may also be determined by calculating whether a number of coordinates included in the contact region is greater than a preset number (i.e., the threshold). For example, according to touch positions touched by the user on the touch panel 110, the controller 120 is capable of obtaining one contact region according to the touch positions and calculating a number of coordinates included in that contact region. If the number of the coordinates in the contact region is greater than the preset number, it is then determined that the touch action includes the palm touch. Otherwise, it is determined that the touch action does not include the palm touch. Nevertheless, said embodiment is merely an example, and the invention is not limited thereto. Alternatively, whether the touch action includes the palm touch may also be determined by comparing a short-side width of each of the contact region with a preset length. When the contact region having the short-side width greater than the preset length exists, it is determined that the touch action includes the palm touch. When the contact region having the short-side width greater than the preset length does not exist, it is determined that the touch action does not include the palm touch.

In addition, whether the touch action includes the palm touch may also be determined according to of the short-width in combination with the area. For example, it is determined that the touch action includes the palm touch only when the short-side width is greater than the preset length and the area is greater than the threshold. Examples provided above are only illustrative, and which of the methods is used in the step regarding how to determine whether the touch action includes the palm touch may be decided based on actual situation.

A learning function is further provided by the touch apparatus 100. That is, in the first use, information (including a finger size, a palm size, and etc.) of the user may be detected and stored as a basis for determining the large-area touching later. For example, the information (including the finger size, the palm size, and etc.) of the user detected in the first use may be taken as a basis for setting the threshold used to determine whether the touch action includes the palm touch. Moreover, the touch apparatus 100 may further record the information (including the finger size, the palm size, and etc.) of different users. In the case of operating by different users, the palm size of each user may be calculated through multiple operations so as to adjust the threshold used to determine whether the touch action includes the palm touch. Because different users may have different hand sizes, a precision of the determination may be improved by using aforesaid learning function.

Under the situation that the touch action includes the palm touch, in step S215, palm touching information corresponding to the palm touch is transformed into mouse controlling information through the mouse simulating device 133 of the touch apparatus 100. Further, in step S220, the mouse controlling information is sent to a mouse driver through the mouse simulating device 133, such that the mouse driver executes mouse operation based on the mouse controlling information.

If the touch action does not include the palm touch, in step S225, the touch controlling device 132 executes a finger touch operation. The controller firmware 131 sends the finger touching information corresponding to the finger touch the touch controlling device 132 for executing the finger touch operation.

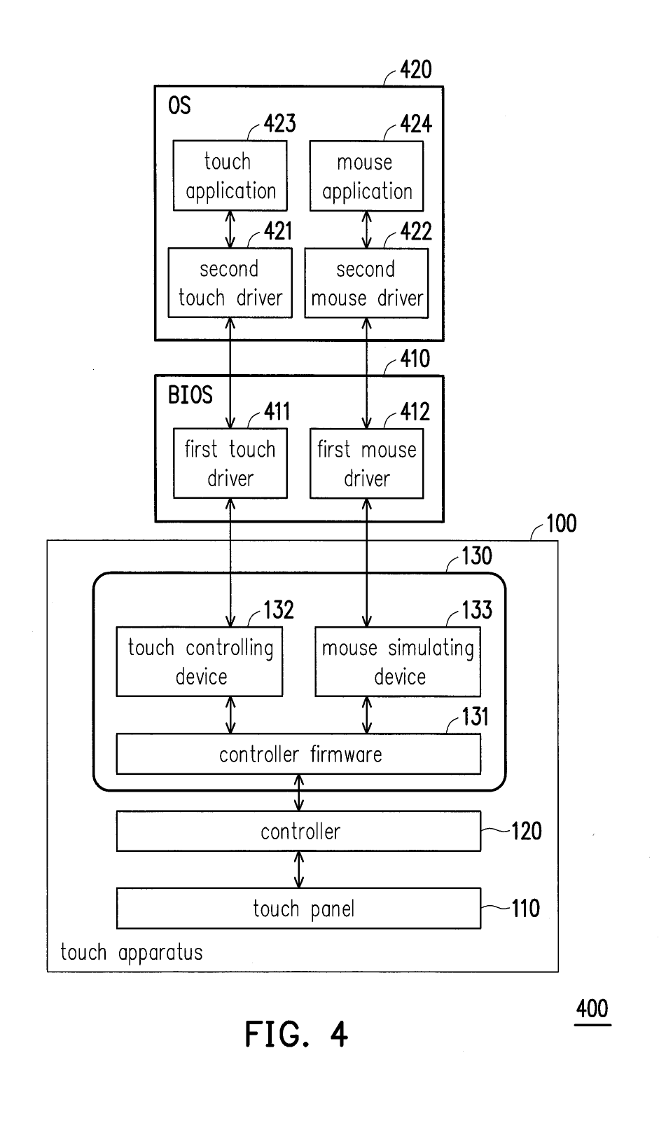

Examples are provided below to describe structures of devices in the electronic apparatus. FIG. 4 is a block diagram of an electronic apparatus according to an embodiment of the invention. Referring to FIG. 4, an electronic apparatus 400 includes a touch apparatus 100, a basic input output system (BIOS) 410 and an operating system (OS) 420. The BIOS 410 includes a first touch driver 411 and a first mouse driver 412. The OS 420 includes a second touch driver 421, a second mouse driver 422, a touch application 423 and a mouse application 424.

The touch apparatus 100 sends touching information to the BIOS 410, and the BIOS 410 sends the touching information to the OS 420. Specifically, when the controller firmware 131 determines that the touch action includes the palm touch, the mouse simulating device 133 transforms the palm touching information corresponding to the palm touch into the mouse controlling information. Further, the mouse simulating device 133 sends the mouse controlling information to the first mouse driver 412 of the BIOS 410, and then the first mouse driver 412 sends the mouse controlling information to the second mouse driver 422 of the OS 420. Accordingly, the second mouse driver 422 sends the mouse controlling information to the mouse application 424, such that the mouse application 424 can execute the mouse operation based on the mouse controlling information.

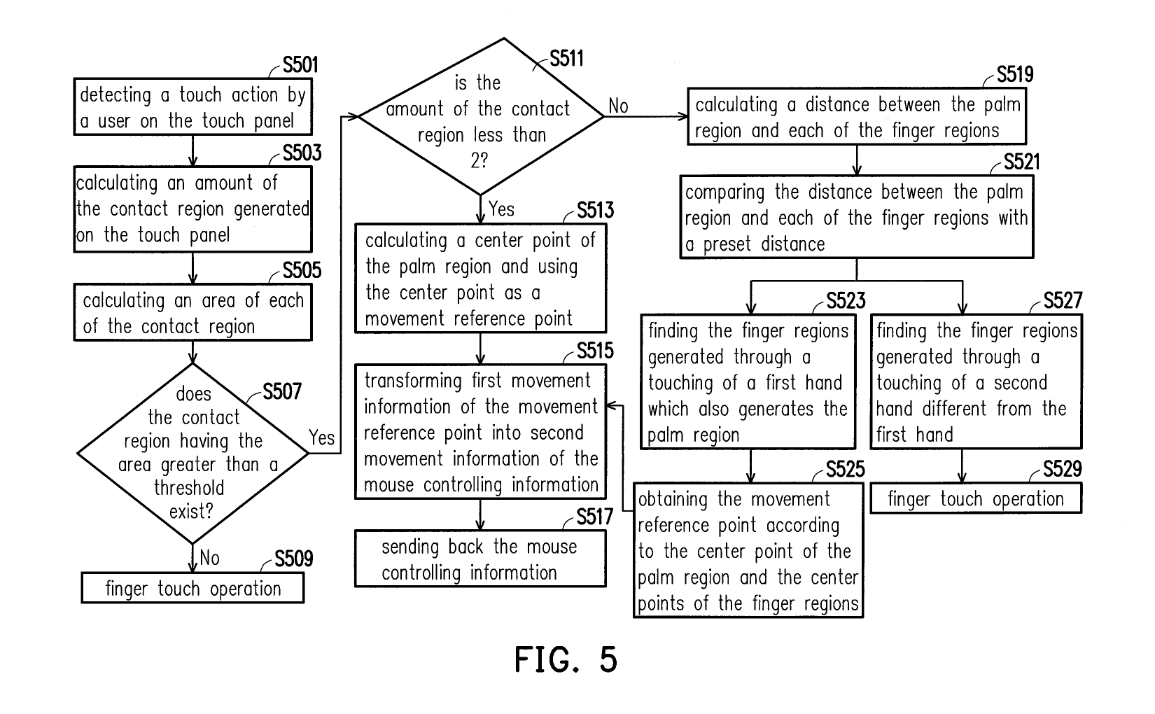

Steps of an operating method of the electronic apparatus 400 are described below with reference to the electronic apparatus 400. FIG. 5 is a flowchart of an operating method of an electronic apparatus according to another embodiment of the invention. Referring to FIG. 4 and FIG. 5 together, in step S501, the controller 120 detects a touch action by a user on the touch panel 110.

Subsequently, in step S503, the controller firmware 131 calculates an amount of contact region generated on the touch panel 110. Further, in step S505, the controller firmware 131 calculates an area of each of the contact region.

Thereafter, in step S507, the controller firmware 131 determines whether the contact region having the area greater than a threshold exists in the detected contact regions. Herein, the threshold is, for example, 144 mm². Generally, an average area touched by the finger is 9 mm×9 mm, and thus this average area plus approximately 30% is used as the threshold (i.e., 12 mm×12 mm (144 mm²)). Nevertheless, said embodiment is merely an example, and the invention is not limited thereto. In other embodiments, based on sizes of the touch panel 110, different users, or different habits of the users, the threshold may be different. In addition, in other embodiments, whether the contact region is the large-area touching (i.e., the palm touch) may also be determined according to whether the short-side width of the contact region is greater than the preset length (e.g., 12 mm).

If the contact region having the area greater than the threshold does not exist, it indicates that the touch action does not include the large-area touching (the palm touch) and then proceeds to step S509 in which the touch controlling device 132 executes a finger touch operation. Specifically, the touch action is considered to be the finger touch when the touch action does not include the palm touch, and the controller firmware 131 sends the finger touching information corresponding to the finger touch the touch controlling device 132 to be sequentially sent to the first touch driver 411 of the BIOS 410, the second touch driver 421 of the OS 420 and the touch application 423 for executing the finger touch operation.

If the contact region having the area greater than the threshold exists, it indicates that the touch action includes the large-area touching (the palm touch) and then proceeds to step S511 in which the controller firmware 131 further determines whether the amount of the contact region is less than 2. This step is used to further determine how many of finger regions generated by the fingers are following a palm region. When the amount of the contact region is less than 2, it indicates that the user is possibly in a state of making a fist; and when the amount of the contact region is not less than 2, it indicates that the user is possibly in a state of opening palm.

When the amount of the contact region is less than 2 (i.e., the amount of the contact region is equal to 1), the controller firmware 131 sets the contact region as the palm region corresponding to the palm touch. Then, in the step S513, a center point of the palm is calculated and the center point is used as a movement reference point. Subsequently, in step S515, the mouse simulating device 133 transforms first movement information of the movement reference point on the touch panel 110 (the palm touching information includes the first movement information) into second movement information of the mouse controlling information. Further, in step S517, the mouse simulating device 133 reports the mouse controlling information. The mouse simulating device 133 sends the mouse controlling information to the mouse application 424 of the OS 420 through the first mouse driver 412 of the BIOS 410 and the second mouse driver 422 of the OS 420.

On the other hand, when the amount of the contact region is not less than 2 (i.e., when the amount of the contact region is greater than or equal to 2), the controller firmware 131 sets one having a greatest area among the contact regions as the palm region corresponding to the palm touch and respectively sets the other contact regions as finger regions corresponding to the finger touch. Subsequently, in step S519, the controller firmware 131 calculates a distance between the palm region and each of the finger regions by calculating the center point of the palm region and a center point of each of the finger regions respectively.

Then, in step S521, the controller firmware 131 compares and calculates the distance between the palm region and each of the finger regions with a preset distance, so as to determine whether the contact regions are generated through a touching of the same first hand, or generated through different touching of the first and a second hand. That is, the finger regions having the distance from the palm region not greater than the preset distance (e.g., 10 cm) are set as regions generated through the touching of the first hand which also generates the palm touch. The finger regions having the distance from the palm region greater than the preset distance are set as regions generated through the touching of the second hand different from the first hand. Accordingly, the contact regions within a specific distance may be considered to be formed by the same hand.

In step S523, the finger regions generated through the touching of the first hand which also generates the palm region are found from among the contact regions based on the distance between the palm region and each of the finger regions. Then, in step S525, the movement reference point is obtained according to the center point of the palm region and the center points of the finger regions generated through the touching of the first hand which also generates the palm region.

Further, in step S527, the finger regions generated through the touching of the second hand different from the first hand are found from among the contact regions based on the distance between the palm region and each of the finger regions. Then, in step S529, the touch controlling device 132 executes the finger touch operation. That is, the touch controlling device 132 of the touch apparatus 100 transforms the finger touching information corresponding to the finger regions of the second hand into the touch controlling information, and the touch controlling device 132 sends the touch controlling information to the touch application 423 through the first touch driver 411 of the BIOS 410 and the second touch driver 421 of the OS 420.

Herein, conditions of step S523 and step S527 may both be true at the same time. That is to say, the touch action may include both the palm touch and the finger touch. When the controller firmware 131 detects that the touch action includes both the palm touch and the finger touch at the same time, the palm touching information corresponding to the palm touch is processed through the mouse simulating device 133, and the finger touching information corresponding to the finger touch is processed through the touch controlling device 132. Accordingly, the user is able to execute the mouse operation by using the palm of the first hand while executing the finger touch operation by using the finger of the second hand.

In addition, the touch action may also include only the palm touch. That is, after the large-area touching (the palm touch) is detected, it is further determined that other small-area touchings (the finger touch) are all generated by the same first hand which generates the large-area touching. In other words, step S521 is used to determine whether the finger region generated through the touching of the second hand different from the first hand exits in the contact regions.

Moreover, the electronic apparatus 400 is also capable of executing the mouse operation and the touch operation generated by the same hand at the same time. That is, the palm touch may be used to simulate the mouse operation in order to move a cursor to a specific region to be clicked. Thereafter, the finger touch may be used to execute a click action (e.g., double click), so as to execute a function corresponding to the specific region. Specifically, when the palm touch is detected by the controller firmware 131, the mouse simulating device 133 simulates the mouse operation by using touch signals corresponding to the palm touch, so that the mouse application 424 of the OS 420 may correspondingly move the cursor to the specific region to be clicked. At the same time, the touch apparatus 100 is still capable of detecting the finger touch generated by the same hand. When the finger touch generated by the same hand is detected by the controller firmware 131, the touch controlling device 132 sends touch signals corresponding to the finger touch to the touch application 423 of the touch application of the OS 420, so that the touch application 423 may execute corresponding actions.

In summary, by disposing both the touch controlling device and the mouse simulating device in the touch apparatus, not only can the mouse operation be realized through the mouse simulating device when the large-area touching (the palm touch) is detected, the touch operation can also be realized through the touch controlling device when a non large-area touching (the finger touch) is detected. Accordingly, the touch apparatus is capable of providing two operating methods of both the touch operation and the mouse operation for the user to operate the electronic apparatus, such that the user is able to perform the specific operation that requires higher precision through the touch apparatus.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An operating method of an electronic apparatus, comprising:
detecting a touch action by a user on a touch panel through a controller of a touch apparatus, so as to obtain at least one contact region touched by the touch action on the touch panel;
determining whether the touch action includes a palm touch based on a size of the contact region;
when the touch action includes the palm touch, transforming palm touching information corresponding to the palm touch into mouse controlling information through a mouse simulating device of the touch apparatus; and
sending the mouse controlling information to a mouse driver through the mouse simulating device, such that the mouse driver executes mouse operation based on the mouse controlling information.

2. The operating method of claim 1, wherein before determining whether the touch action includes the palm touch, the operating method further comprises:
calculating an amount of the contact region generated on the touch panel;
wherein when the touch action includes the palm touch, the operating method further comprises:
when the amount of the contact region is less than 2, setting the contact region as a palm region corresponding to the palm touch;
calculating a center point of the palm region and using the center point as a movement reference point; and
transforming first movement information of the movement reference point on the touch panel into second movement information of the mouse controlling information, wherein the palm touching information includes the first movement information.

3. The operating method of claim 2, wherein after calculating the amount of the contact region generated on the touch panel, and when the touch action includes the palm touch, the operating method further comprises:
when the amount of the contact region is greater than or equal to 2, setting one having a greatest area among the contact regions as the palm region corresponding to the palm touch and setting each of the remaining contact regions as a finger region corresponding to a finger touch;
calculating a distance between the palm region and each of the finger regions by calculating the center point of the palm region and a center point of each of the finger regions respectively;
finding the finger regions generated through a touching of a first hand which also generates the palm region from among the contact regions based on the distance between the palm region and each of the finger regions;
obtaining the movement reference point according to the center point of the palm region and the center points of the finger regions generated through the touching of the first hand which also generates the palm region; and
transforming the first movement information of the movement reference point on the touch panel into the second movement information of the mouse controlling information through the mouse simulating device of the touch apparatus.

4. The operation method of claim 3, wherein after calculating the distance between the palm region and each of the finger regions, the operating method further comprises:
comparing the distance between the palm region and each of the finger regions with a preset distance;
setting the finger regions having the distance from the palm region not greater than the preset distance as regions generated through the touching of the first hand; and
setting the finger regions having the distance from the palm region greater than the preset distance as regions generated through a touching of a second hand.

5. The operation method of claim 3, wherein after calculating the distance between the palm region and each of the finger regions, the operating method further comprises:
determining whether the finger regions generated through a touching of a second hand different from the first hand exist in the contact regions based on the distance between the palm region and each of the finger regions;
if the finger regions generated through the touching of the second hand exist in the contact regions, transforming finger touching information corresponding to the finger regions into touch controlling information through a touch controlling device of the touch apparatus, and sending the touch controlling information to a touch driver through the touch controlling device.

6. The operating method of claim 1, wherein the step of determining whether the touch action includes the palm touch based on the size of the contact region comprises:
determining whether an area of each of the contact region is greater than a threshold;
determining that the touch action includes the palm touch when the contact region having the area greater than threshold exists; and
determining that the touch action does not include the palm touch when the contact region having the area greater than threshold does not exist.

7. The operating method of claim 1, wherein the step of determining whether the touch action includes the palm touch based on the size of the contact region further comprises:
comparing a short-side width of each of the contact region with a preset length;
determining that the touch action includes the palm touch when the contact region having the short-side width greater than the preset length exists; and
determining that the touch action does not include the palm touch when the contact region having the short-side width greater than the preset length does not exist.

8. A touch apparatus, comprising:
a touch panel;
a controller, coupled to the touch panel, and configured to detect a touch action by a user on the touch panel, so as to obtain at least one contact region touched by the touch action on the touch panel; and
a storage unit, coupled to the controller, and comprising a controller firmware, a mouse simulating device and a touch controlling device, wherein the controller firmware, the mouse simulating device and the touch controlling device are executed by the controller;
wherein the controller firmware determines whether the touch action includes a palm touch based on a size of the contact region; and when the touch action includes the palm touch, the mouse simulating device transforms palm touching information corresponding to the palm touch into mouse controlling information, and the mouse simulating device sends the mouse controlling information to a mouse driver, such that the mouse driver executes mouse operation based on the mouse controlling information.

9. The touch apparatus of claim 8, wherein the controller firmware calculates an amount of the contact region generated on the touch panel, and calculates an area of each of the contact region, so as to determine whether the touch action includes the palm touch; when the touch action includes the palm touch and the amount of the contact region is less than 2, the controller firmware sets the contact region as a palm region corresponding to the palm touch, and calculates a center point of the palm region and uses the center point as a movement reference point; and
the mouse simulating device transforms first movement information of the movement reference point on the touch panel into second movement information of the mouse controlling information, wherein the palm touching information includes the first movement information.

10. The touch apparatus of claim 9, wherein when the touch action includes the palm touch and the amount of the contact region is greater than or equal to 2, the controller firmware sets one having a greatest area among the contact regions as the palm region corresponding to the palm touch and sets each of the remaining contact regions as a finger region corresponding to a finger touch, calculates a distance between the palm region and each of the finger regions by calculating the center point of the palm region and a center point of each of the finger regions respectively, finds the finger regions generated through a touching of a first hand which also generates the palm region from among the contact regions based on the distance between the palm region and each of the finger regions, and obtains the movement reference point according to the center point of the palm region and the center points of the finger regions generated through the touching of the first hand which also generates the palm region; and
the mouse simulating device transforms the first movement information of the movement reference point on the touch panel into the second movement information of the mouse controlling information.

11. The touch apparatus of claim 10, wherein after calculating the distance between the palm region and each of the finger regions, the controller firmware determines whether the distance between the palm region and each of the finer regions is greater than a preset distance, so as to set the finger regions having the distance from the palm region not greater than the preset distance as regions generated through the touching of the first hand, and set the finger regions having the distance from the palm region greater than the preset distance as regions generated through a touching of a second hand.

12. The touch apparatus of claim 10, wherein the controller firmware determines whether the finger regions generated through a touching of a second hand different from the first hand exist in the contact regions based on the distance between the palm region and each of the finger regions;
if the finger regions generated through the touching of the second hand exist in the contact regions, the touch controlling device transforms finger touching information corresponding to the finger regions into touch controlling information, and the touch controlling device sends the touch controlling information to a touch driver.

13. The touch apparatus of claim 8, wherein the controller firmware determines whether an area of each of the contact region is greater than a threshold, determines that the touch action includes the palm touch when the contact region having the area greater than threshold exists, and determines that the touch action does not include the palm touch when the contact region having the area greater than threshold does not exist.

14. The touch apparatus of claim 8, wherein the controller firmware compares a short-side width of each of the at least contact region with a preset length, determines that the touch action includes the palm touch when the contact region having the short-side width greater than the preset length exists, and determines that the touch action does not include the palm touch when the contact region having the short-side width greater than the preset length does not exist.
